(19) United States
(12) Patent Application Publication
(10) Pub. No.: US 2024/0346417 A1
(43) Pub. Date: Oct. 17, 2024

(54) A METHOD OF CONTROLLING SITE SAFETY OPERATIONS BASED ON PPE COMPLIANCE

(71) Applicant: Eaton Intelligent Power Limited, Dublin (IR)

(72) Inventors: James Patrick RYLE, Dublin (IE); Kaushal JOSHI, Haldwani (IN); Mijaz MUKUNDAN, Kannur (IN); Juhi AJMERA, Udaipur (IN); Sivaprasad NANDYALA, pune (IN); Saurabh PATHAK, Bahraich (IN)

(21) Appl. No.: 18/294,323

(22) PCT Filed: Oct. 18, 2021
(86) PCT No.: PCT/EP2021/078848

§ 371 Date: Feb. 1, 2024

(30) Foreign Application Priority Data
Aug. 12, 2021 (IN) 202111036490

(51) Int. Cl. G06Q 10/0635; G06Q 50/26; G06V 10/82; G06V 20/52; G06V 40/10; G07C 9/32

(52) U.S. Cl. CPC G06Q 10/0635; G06Q 50/265; G06V 10/82; G06V 20/52; G06V 40/10; G07C 9/32

(57) ABSTRACT

The disclosure provides a computer-implemented method of controlling safety operations at a designated site associated with Personal Protective Equipment (PPE) requirements. The method comprises: receiving sensor data from a sensor system monitoring the site; detecting an individual at the site based on the sensor data; identifying one or more items of PPE present on the individual based on the sensor data; determining a compliance score associated with the individual based, at least in part, on the one or more identified items of PPE and a PPE checklist associated with the designated site, the PPE checklist comprising one or more prescribed items of PPE; comparing the compliance score to a safety threshold; and controlling one or more safety operations at the site in dependence on the comparison between the determined compliance score and the safety threshold.

### TECHNICAL FIELD

The present disclosure relates generally to a method of controlling safety operations at a site based on the compliance of an individual with Personal Protective Equipment (PPE) requirements. Aspects of the disclosure relate to a method, and to a control system.

### BACKGROUND

It is common for an individual to wear PPE for protection in a hazardous environment, such as a construction site, and/or for mitigating the spread of infectious disease, particularly in an enclosed space such as a hospital, venue or workplace. PPE items typically include gloves, goggles and other eye coverings, as well as protective face masks, high-visibility clothing, and helmets. Other items of PPE may also be suitable depending on the particular risks presented by the environment and/or the activities undertaken by the individual at a particular site.

Visual checks for PPE are often performed at points of access, i.e. entrances and/or exits, to such sites to ensure that an individual is suitably protected and compliant with the respective PPE requirements. However, visual checks are susceptible to human error and PPE infractions can occur, particularly where defects in the PPE go unnoticed, compromising the safety and PPE compliance of individuals at the site.

It is against this background that the disclosure has been devised.

### SUMMARY OF THE DISCLOSURE

According to an aspect of the disclosure there is provided a computer-implemented method of controlling safety operations at a designated site associated with Personal Protective Equipment (PPE) requirements. The method comprises: receiving sensor data from a sensor system monitoring the site; detecting an individual at the site based on the sensor data; identifying one or more items of PPE present on the individual based on the sensor data; determining a compliance score associated with the individual based, at least in part, on the one or more identified items of PPE and a PPE checklist associated with the designated site, the PPE checklist comprising one or more prescribed items of PPE; comparing the compliance score to a safety threshold; and controlling one or more safety operations at the site in dependence on the comparison between the determined compliance score and the safety threshold.

In this manner, the method automatically detects an individual at the site (i.e. in and/or around the site in an area observed by the sensors system) and assesses the compliance of the individual with respective PPE requirements for the individual/the site, as defined by the PPE checklist. One or more safety operations are then executed in dependence on whether or not the detected individual complies with the PPE checklist, for example granting/inhibiting access to restricted areas of the site, dispensing PPE and/or generating notifications of PPE compliance issues. In this manner, the method provides for enhanced safety of individuals at the site, mitigating PPE infractions, and encouraging compliance with the PPE requirements.

For example, the sensor data may comprise: a recorded image of the individual at the site; an identification tag detected on an individual at the site; and/or a key code provided by an individual at the site.

In an example, the sensor data may comprise the recorded image of the individual at the site. The individual may, for example, be detected and/or the one or more items of PPE may be identified based, at least in part, on an image processing technique applied to the recorded image of the detected individual.

Optionally, the method further comprises determining: an identity of the detected individual; a job title of the detected individual; and/or an undertaking (i.e. an assigned or assumed task) of the detected individual at the designated site; based on the sensor data. Optionally, the method further comprises determining the PPE checklist based on the determined identity, job title, and/or undertaking of the detected individual.

In an example, the method further comprises classifying the detected individual according to the determined identity, job title, and/or undertaking of the detected individual, the classification being associated with one or more respective PPE requirements. Optionally, the method further comprises determining the PPE checklist based on the classification.

Optionally, determining the compliance score associated with the detected individual comprises: determining whether the one or more prescribed items of PPE are identified on the detected individual; assessing the integrity of the one or more identified items of PPE based on the sensor data; and/or determining whether the one or more identified items of PPE are worn as prescribed for protecting the detected individual based on the sensor data.

For example, determining the compliance score may comprise assessing the integrity of the one or more identified items of PPE. Assessing the integrity may, for example, comprise: retrieving one or more usage records associated with the one or more identified items of PPE from an inventory database, each usage record being indicative of the condition of a respective item of PPE; and/or applying an image processing technique to a recorded image of the detected individual in the sensor data to inspect the one or more identified items of PPE for visible defects.

For example, each usage record may store information indicative of the health or condition of the identified item of PPE. For example, each usage record may comprise at least one of: a date of purchase; an expiry date; a usage record; a usage limit; and/or the identification of a previous user; for the identified item of PPE.

Optionally, the image processing technique comprises a machine learning algorithm for detecting the visible defect in the recorded image. The image processing technique may, for example, detect the visible defect using an edge detection technique, and/or using a colour identification technique for identifying discolouration of the identified item of PPE.

Optionally, determining the compliance score comprises determining whether the one or more identified items of PPE are worn as prescribed for protecting the detected individual. Optionally, determining whether the one or more identified items of PPE are worn as prescribed may comprise: determining a position of each identified item of PPE on the detected individual; and comparing the determined position of said item of PPE to a position prescribed for said item of PPE in the PPE checklist.

In an example, determining the position of each identified item of PPE comprises localising the identified item of PPE on the detected individual using an object recognition technique applied to a recorded image of the detected individual in the sensor data. Preferably, the object recognition technique may comprise a convolutional neural network. More preferably, the object recognition technique may comprise a you-only-look-once convolutional neural network.

Optionally, the PPE checklist includes a plurality of prescribed items of PPE, and determining the compliance score may comprise: determining, for each of the prescribed items of PPE, an item compliance score indicative of the presence of the prescribed item of PPE on the detected individual, the integrity of said item of PPE, and/or whether the item of PPE is worn as prescribed for protecting the detected individual. The compliance score may be determined as a weighted average of the item compliance scores, for example.

In an example, executing the one or more safety operations at the site may comprise: controlling one or more site restrictions; dispensing one or more items of PPE at the site; and/or controlling a notification system to indicate the compliance of the detected individual with the PPE checklist.

In an example, the individual may be detected at an entrance and/or an exit to the site, and controlling the one or more site restrictions may comprise controlling a state of the entrance and/or the exit for the detected individual.

Optionally, the one or more site restrictions may be controlled to: enable the detected individual to perform the determined undertaking in dependence on the compliance score being greater than, or equal to, the safety threshold; and/or inhibit the detected individual from performing the determined undertaking in dependence on the compliance score being less than the safety threshold.

Optionally, the method further comprises monitoring the individual, once detected, to detect a change in the one or more identified items of PPE present on the detected individual based on the sensor data. The compliance score may, for example, be determined periodically, and/or in dependence on detecting the change in the one or more identified items of PPE present on the detected individual.

Optionally, the method further comprises: removing one or more site restrictions in dependence on the determined compliance score increasing to, or above, the safety threshold; and/or applying one or more site restrictions in dependence on the determined compliance score decreasing below the safety threshold.

In an example, the method further comprises: determining a proximity of the monitored individual to another individual at the designated site based on the sensor data, and determining the compliance score based, at least in part, on the determined proximity being less than a threshold proximity for social distancing.

Optionally, the sensor data comprises a recorded image of the detected individual and the other individual at the site. The proximity may, for example, be determined by: locating the detected individual in the recorded image; locating the other individual in the recorded image; determining an image distance, in pixels, from the detected individual to the other individual; and determining the proximity using a scalar conversion from the image distance to a physical distance, where the scalar conversion is based, at least in part, on a focal length of an image sensor that recorded the image.

Optionally, the method further comprises determining the scalar conversion by: determining a first boundary box for the detected individual in the recorded image; determining a second boundary box for the other individual in the recorded image; determining a first length, in pixels, of the first boundary box and a second length, in pixels, of the second boundary box; determining a first scalar conversion from a pixel in the first boundary box to a physical distance based on: a focal length of the image sensor, a reference size of the detected individual and the first length; determining a second scalar conversion from a pixel in the second boundary box to a physical distance based on: a focal length of the image sensor, a reference size of the other individual and the second image length; and averaging the first and second scalar conversions.

In an example, the method further comprises: determining the threshold proximity based on the one or more identified items of PPE.

According to another aspect of the disclosure there is provided a control system for controlling safety operations at a designated site associated with Personal Protective Equipment (PPE) requirements. The control system is configured to execute instructions to: receive sensor data from a sensor system monitoring the site; detect an individual at the site based on the sensor data; identify one or more items of PPE present on the individual based on the sensor data; determine a compliance score associated with the individual based, at least in part, on the one or more identified items of PPE and a PPE checklist associated with the site; compare the compliance score to a safety threshold; and control one or more safety operations at the site in dependence on the comparison between the determined compliance score and the safety threshold.

According to yet another aspect of the disclosure there is provided a computer-implemented method of controlling safety operations at a designated site associated with social distancing requirements. The method comprises: receiving a recorded image from a sensor system monitoring the site; locating first and second individuals in the recorded image; determining an image distance, in pixels, from the first individual to the second individual; determining a proximity of the first and second individuals using a scalar conversion from the image distance to a physical distance, where the scalar conversion is based, at least in part, on a focal length of an image sensor that recorded the image; and controlling one or more safety operations at the site in dependence on the determined proximity.

It will be appreciated that preferred and/or optional features of each aspect of the disclosure may be incorporated alone or in appropriate combination in the other aspects of the disclosure also.

### BRIEF DESCRIPTION OF THE DRAWINGS

Examples of the disclosure will now be described with reference to the accompanying drawings, in which:

FIG. 1 shows an exemplary implementation of an embodiment of the disclosure at a designated site;

FIG. 2 shows a schematic view of an exemplary control system for controlling safety operations at the site shown in FIG. 1;

FIG. 3 shows the steps of an example method of operating the control system shown in FIG. 2;

FIG. 4 shows exemplary sub-steps of the method shown in FIG. 3;

FIG. 5 shows further exemplary sub-steps of the method shown in FIG. 3;

FIG. 6 shows the steps of another example method of operating the control system shown in FIG. 2 to assess compliance with social distancing protocols; and

FIG. 7 shows an exemplary image recorded for assessing compliance with social distancing protocols according to the method shown in FIG. 6.

### DETAILED DESCRIPTION

Embodiments of the disclosure relate to a computer-implemented method, and to a control system, for controlling safety operations at a designated site, such as a workplace, hospital, or venue, where PPE is required.

According to the method, the site is monitored by a sensor system, which generates sensor data for detecting an individual at the site and evaluating their compliance with a PPE checklist. The PPE checklist includes one or more prescribed items of PPE that may be required due to site safety requirements, and/or specific safety requirements of the detected individual and/or their undertakings at the site. For example, a high visibility jacket may be required for certain individuals working around heavy machinery, whilst face masks may be required in enclosed spaces to help reduce the spread of airborne particles in the case of infectious diseases.

In order to evaluate the extent to which the detected individual is compliant with the PPE requirements, the sensor data is processed to identify any items of PPE that are present on the individual and a compliance score is determined by comparing the identified items of PPE to the PPE checklist. For an objective assessment, the compliance score may be determined by taking a range of risk factors into account, including the presence or absence of the prescribed item(s) of PPE, the integrity of the identified item(s) and/or whether the identified item(s) of PPE are worn as prescribed for protecting the detected individual, i.e. based on the positioning of the identified item(s) of PPE. Each of these risk factors may be determined based on the sensor data generated by the sensor system.

The compliance of the individual is then evaluated by comparing the determined compliance score to a safety threshold and one or more safety operations at the site are controlled in dependence on the comparison. For example, if the determined compliance score is less than the safety threshold, one or more alerts or notifications may be generated, access to the site may be inhibited, and/or appropriate PPE equipment may be dispensed for the individual.

It is anticipated that the method will therefore lead to enhanced safety of individuals at the site, reducing or substantially eliminating PPE infractions, and encouraging further compliance with the PPE requirements.

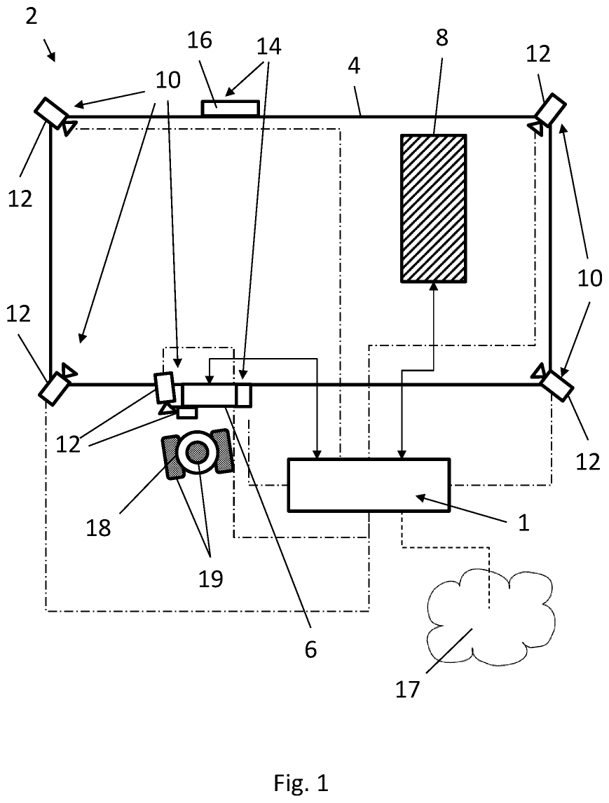

FIG. 1 schematically illustrates an exemplary implementation of a control system 1 for controlling safety operations at a designated site 2 in accordance with an embodiment of the disclosure.

In this example, the designated site 2 is a workplace, where PPE is required to ensure the health and safety of staff and/or visitors. The site 2 may be an enclosed space, as in this example, with a fenced, or otherwise guarded, perimeter 4 restricting access to the site 2 and a gateway 6 acting as an entrance and/or exit to the site 2. However, this example is not intended to be limiting on the scope of the disclosure and, in other examples, the designated site may be accessible without restrictions. The site 2, shown in FIG. 1, also includes a restricted operating area 8 which is associated with one or more further PPE requirements, such as a hard hat, that are applicable to individuals with undertakings (i.e. assigned or assumed tasks) in the restricted operating area 8. Accordingly, in this example, a PPE checklist for assessing compliance at the site 2 may vary in dependence on the identity, job and/or undertakings of respective individuals at the site 2.

The designated site 2 is monitored by a sensor system 10 and the sensor system 10 is configured to transmit sensor data, such as images or other signals, to the control system 1 for assessing the compliance of one or more individuals at the site 2 with a respective PPE checklist. For this purpose, the sensor system 10 may include one or more sensors 12, including one or more imaging cameras, transmitters, receivers, or scanners (such as a bar code or QR code scanner), arranged to monitor areas of interest within and around the site 2.

In order to assess the compliance of the individual(s) at the site 2 with the PPE checklist, the one or more sensors 12 may be configured to generate suitable sensor data in various forms. For example, the sensors 12 may be configured to obtain image(s) of individual(s) at the site 2, to wirelessly communicate with one or more transponder devices on the individual(s), and/or to receive an identifier, such as a key code, for such purposes. To give an example, the one or more sensors 12 at the site 2 may include a set of imaging cameras and one or more radio transmitter-receivers, also known as interrogators, configured to send signals to a Radio-frequency identification (RFID) tag present on an individual at the site 2 and to read response signals therefrom. In this manner, the one or more sensors 12 may be configured to record images of an individual at the site 2 and/or to scan for responses from the RFID tag. The radio transmitter-receivers may be conveniently positioned at the gateway 6, for example, to detect individuals at the entrance to the site 2, as a primary point of detection, and the imaging cameras may be arranged around the site 2 to monitor areas of interest. It shall be appreciated that, in this and other examples, the one or more sensors 12 may be provided by an existing CCTV infrastructure at the site 2 without need for expensive hardware and infrastructure replacement. Where necessary, parts of the sensor system 10 (such as one or more radio transmitter-receivers) may be retrofitted as supplementary sensors for monitoring the site 2.

The site 2 also includes one or more site safety systems 14 that are controllable by the control system 1 to execute respective safety operations in order to support compliance of individuals at the site 2 with the PPE requirements.

In the example shown in FIG. 1, the site safety systems 14 include the gateway 6 and an alert or notification system 16. The gateway 6 may be controlled by the control system 1 to allow or inhibit an individual from entering or exiting the site 2 in dependence on the compliance of the individual with the PPE checklist. For example, an individual 18 is illustrated at the site 2, outside the gateway 6 in an area monitored by the sensor system 10, and the gateway 6 may be operated to control whether the individual 18 can enter or exit the site 2 in dependence on the compliance of the individual 18 with the PPE checklist. The notification system 16 may be operated by the control system 1 to generate notifications indicative of the compliance of the individual 18 with the PPE checklist. For example, the notification system 16 may include a display screen and/or a speaker for providing suitable audio or visual notifications. Additionally or alternatively, the notification system 16 may be configured to provide such notifications by way of digital alerts, such as an email or text delivered to an electronic device associated with the site 2 or relevant individual(s). In this manner, the gateway 6 and the notification system 16 may be operated by the control system 1 to support PPE compliance at the site 2.

It shall be appreciated that, in other examples, the control system 1 may control one or more additional or alternative safety operations at the site 2, such as the dispensation of items of PPE, and/or the operation of certain machines, based on the compliance of the detected individual(s) with the PPE requirements.

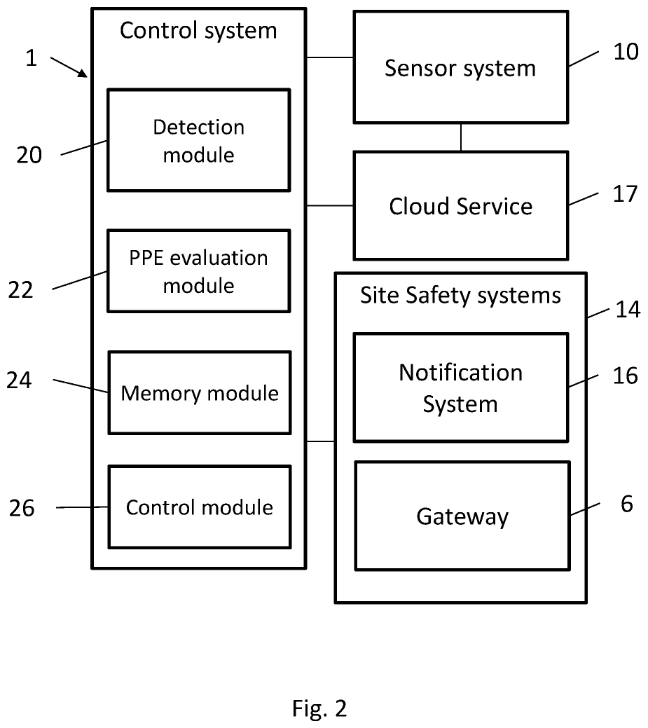

In overview, the control system 1 is therefore configured to: i) receive sensor data from the sensor system 10, ii) use the sensor data to determine a compliance score indicative of the compliance of individual(s) at the site 2 with the PPE requirements, and iii) control the site safety systems 14 based on the compliance score to execute various operations supporting the safety and PPE compliance of the individual(s) at the site 2. The control system 1 shall now be considered in further detail with additional reference to FIG. 2.

FIG. 2 illustrates a non-limiting example of the control system 1, which is shown to be connected via appropriate network connections to the sensor system 4 and the site safety systems 14.

In this example, the control system 1 and the sensor system 10 are also shown to connect via appropriate network connections to a cloud service 17, which may provide off-line analysis of sensor data, and/or training of the control system 1, if necessary and conditions allow.

In this example, the control system 1 is shown to include a detection module 20, a PPE evaluation module 22, a memory module 24, and a control module 26. That is, in the described example four functional elements, units or modules are shown. Each of these units or modules may be provided, at least in part, by suitable software running on any suitable computing substrate using conventional or custom processors and memory. Some or all of the units or modules may use a common computing substrate (for example, they may run on the same server) or separate substrates, or different combinations of the modules may be distributed between multiple computing devices.

The detection module 20 is configured to detect, identify and/or classify an individual at the site 2 based on the sensor data received from the sensor system 4. In particular, the detection module 20 may be configured to detect, identify, and/or classify the individual based on a recorded image; a response signal received from an identification tag; and/or an access key received from the detected individual. For example, the detection module 20 may be configured to process the sensor data received from the sensor system 10 to detect the individual at the site 2 and determine an identity of the detected individual, and/or whether the detected individual is a member of staff at the site 2, having one or more associated undertakings or responsibilities at the site 2. Such information may be determined based on the response signal received from the identification tag, the access key received from the detected individual, and/or by applying one or more image processing techniques to the recorded image. For example, an image processing technique may be applied to recognise facial features of the individual in the recorded image and thereby to identify the individual. Alternatively or additionally, an image processing technique may be applied to recognise a uniform or an item of PPE that the individual is wearing, and thereby to determine the job of the individual at the site 2, for example based on the colour of the uniform or item of PPE.

In this example, the control system 1 is configured to determine a respective PPE checklist for assessing the compliance of each detected individual with the PPE requirements at the site 2. Hence, the detection module 20 may use the information that is indicative of the identity and/or job of the detected individual to lookup or classify the individual with reference to a classification scheme, or database, which includes respective PPE requirements associated with the designated site 2. For example, the detection module 20 may be configured to classify the detected individual according to their identity, job, and/or undertakings at the site 2, as indicated by the sensor data, and thereby determine the respective PPE checklist based on the one or more PPE requirements associated with the classification. The classification scheme may be stored in the memory module 24, for example, and the detection module 20 may access memory module 24 to classify detected individuals. The PPE requirements stored for respective classifications in the classification scheme may therefore be configurable by a system administrator.

It shall be appreciated that the detection module 20 may include one or more rules, procedures and/or algorithms for detecting and classifying an individual at the site 2, which may be pre-programmed by the manufacturer or otherwise determined, or refined, by machine learning. For example, the detection module may include one or more machine learning algorithms for detecting and/or classifying an individual at the site 2 based on the sensor data, where such machine learning algorithms may be trained based on labelled datasets and/or a physics/mechanics-based model.

The above-described example is not intended to be limiting though and, in other examples, the PPE checklist used for assessing the compliance of the detected individuals with the PPE requirement of the site 2 may not vary in dependence on the detected individuals. Accordingly, in other examples, classification or identification of the detected individual is not necessary and the identification module 20 may only be configured to detect an individual at the site 2 based on the sensor data.

The PPE evaluation module 22 uses the PPE checklist to assess the compliance of the detected individual with the respective PPE requirements at the site 2. For this purpose, the PPE evaluation module 22 is configured to identify one or more items of PPE present on the detected individual based on the sensor data and to determine a compliance score associated with the detected individual based on the identified item(s) of PPE. For example, where the sensor data comprises a recorded image of the individual at the site, the PPE evaluation module 22 may be configured to identify the item(s) of PPE on the individual by applying one or more suitable image processing techniques. Such image processing techniques may include a machine learning algorithm trained to identify items of PPE, for example having been trained based on labelled images of respective items of PPE. Alternatively, or additionally, the sensor data may include an identification code for a respective item of PPE present on the individual, which may be provided as part of a response signal received from an identification tag or from a scanned code, such as a product code, on the item of PPE. The PPE evaluation module 22 may be configured to identify the item(s) of PPE accordingly based on such identification codes in the sensor data.

For some items of PPE, such as non-consumable items of PPE (i.e. non single use items of PPE), the PPE evaluation module 22 may also be configured to identify the item(s) of PPE with reference to a PPE inventory database. The PPE inventory database may include a plurality of previously registered items of PPE for use at the site 2, along with respective information, such as identification codes or image data, for identifying the respective items. In this manner, the PPE evaluation module 22 may receive sensor data comprising an identification code generated by a transponder device and the PPE evaluation module 22 may compare the identification code to the information stored in the PPE inventory database to identify the item of PPE. For each newly detected item of PPE, the control system 1 may update the PPE inventory database with respective data to keep a record of items of PPE provided or used at the site 2. In an example, the PPE inventory database may further store health or usage records associated with each of the registered items of PPE. For example, each usage record may store information that is indicative of the integrity or effectiveness of the respective item of PPE, such as: a date of purchase; an expiry date; a usage record; a usage limit; and/or the identification of a previous user. The PPE inventory database may also be stored in the memory module 24, for example, and the PPE inventory database may be accessed by the PPE evaluation module 22 to identify the item(s) of PPE.

To assess the extent to which the identified item(s) of PPE satisfy the PPE checklist, the PPE evaluation module 22 is further configured to determine a compliance score based on the identified item(s) of PPE. For this purpose, the PPE evaluation module 22 may include a set of rules, functions and/or build a compliance matrix for determining the compliance score based on the identified item(s) of PPE.

In particular, to assess compliance objectively, the PPE evaluation module 22 may be configured to determine the compliance score based on various risk factors, including: the presence or absence of the prescribed item(s) of PPE set out in the PPE checklist, the integrity of the identified items and/or whether the one or more identified items of PPE are worn as prescribed for protecting the detected individual, i.e. based on the positioning of the identified item(s) of PPE. These risk factors may be assessed by determining respective scores, which may be binary or non-binary, and the risk factors may be combined to determine an overall compliance score according to the prescribes set of rules, algorithms or the compliance matrix. For example, where the PPE checklist includes a plurality of prescribed items of PPE, the PPE evaluation module 22 may be configured to determine, for each of the prescribed items of PPE, an item compliance score indicative of the presence of the prescribed item of PPE on the detected individual, the integrity of said item of PPE, and/or whether the item of PPE is worn as prescribed for protecting the detected individual. The overall compliance score may then be determined as a weighted average of the item compliance scores. The respective weightings may be stored in the classification scheme, for example, and the weightings may thus be configurable by a system operator.

The risk factors described in this example are not intended to be limiting on the invention though and, in other examples, the compliance score may be determined based solely on the correspondence between the prescribed item(s) of PPE and the identified item(s) of PPE, or in combination with one or more other risk factors.

It shall be appreciated that the PPE evaluation module 22 may be configured to assess the integrity of the identified item(s) of PPE by various means. To give an example, the integrity may be assessed based on a usage record, as described above, associated with the identified item of PPE, which may be retrieved from the PPE inventory database. For example, the PPE evaluation module 22 may compare one or more parameters in the usage record, such as a recorded number of uses of the item, to a respective threshold, such as a usage limit. In another example, the integrity may be assessed additionally or alternatively by applying an image processing technique to inspect an item of PPE that has been identified in a recorded image for visible defects. For example, the PPE evaluation module 22 may assess the integrity by means of a computer-implemented visual inspection method configured to recognise cracks, tears, dents, discolouration, and other abnormal features in the image of the identified item of PPE. For this purpose, the PPE evaluation module 22 may therefore include a machine learning algorithm trained to assess the integrity of PPE equipment. The machine learning algorithm may, for example, be configured to recognise such abnormal features or defects using an edge detection technique, and/or by identifying discolouration of the identified item of PPE. For example, an edge detection technique may be used to isolate and identify defect(s) in an item of PPE, such as cracks and tears, whilst a colour identification technique may be used for identifying discolouration of the identified item of PPE. The PPE evaluation module 22 may communicate any identified defects to the PPE inventory database so that the control system 1 can help identify when new PPE should be procured and/or to trigger the supply of new items of PPE. It shall be appreciated that the PPE evaluation module 22 may include one or more rules or algorithms for determining a respective score that is indicative of the impact of any detected defects on the integrity of the PPE.

The PPE evaluation module 22 may similarly be configured to determine whether the one or more identified items of PPE are worn as prescribed for protecting the detected individual by various means. To give an example, the PPE evaluation module 22 may be configured to determine a position of each identified item of PPE on the detected individual; and determine whether the item of PPE is being worn as prescribed for protecting the individual by comparing the determined position of said item of PPE to a prescribed arrangement for said item of PPE. The prescribed arrangement for said item of PPE may be stored in the PPE inventory database, for example, or the prescribed arrangement may be defined by one or more algorithms, or rules, that may be trained or otherwise determined based on labelled datasets and/or physical/mathematical models.

To determine the position of each identified item of PPE on the individual, the PPE evaluation module 22 may include an object detection algorithm configured to localise the identified item of PPE on the detected individual in the recorded image. The object detection algorithm may include a convolutional neural network, for such purposes, such as a you-only-look-once (YOLO) convolutional neural network (CNN), or a Faster R-CNN, for example. Such localisation methods are not described in detail here to avoid obscuring the invention. Nonetheless, more information can be found in the discussion in “Yolov3: An incremental improvement” by Redmon, Joseph, and Ali Farhadi (2018), for example.

It shall be appreciated that the algorithms described above for determining the compliance score may be pre-programmed by the manufacturer or otherwise determined, or refined, by machine learning algorithms of the control system 1, which may be trained based on labelled datasets and/or a physics/mechanics-based models.

Considered in more detail, the training procedure for the machine learning algorithms of the detection module 20 and/or the PPE evaluation module 22 may be prepared as trained models that may be deployed at an appropriate computation location (at the control system 1 or the cloud service 17). Training the model is a standard operation required to enable operation of the control system 1. For example, the training procedure for the machine learning models may follow a continuous improvement methodology, in which the dataset used for training each model is divided into training, validation and test datasets. The training dataset may be used for training with some adjustable hyperparameters, such as the number of layers in a convolution neural network. Once training is complete, each model may be tested against a validation set and hyperparameters may be adjusted to improve the chosen matrices, for example to improve accuracy, precision, and/or recall. Once the models exhibit the required performance, they will be tested against a test dataset and, if the results are within acceptable tolerances, the models are published to a database, which may be stored in the memory module 24 of the control system 1. Otherwise the process may be repeated until results are satisfactory.

It shall be appreciated that the accuracy of the image processing algorithms will vary due to a number of reasons, including background, location, and/or lighting, of the recorded images. In order to build in continued improvement to the accuracy of the deployed algorithms, the control system 1 includes the capability to regularly update the algorithms. Hence, during set up of the control system 1, or as per a configurable interval parameter, the control system 1 may check if the algorithms are up to date with respect to the cloud service 17. If the algorithms are not up to date, synced or operational due to a fault, the algorithms may be updated or reverted to the previous working version.

The memory module 24 may be configured to interact over appropriate network connections with the cloud service 17 for providing updates, corrections, or additions to the databases and/or classification schemes, as well as updating parameters and/or models used for image based recognition. For the purpose of receiving and/or storing such data, the memory module 24 may take the form of a computer-readable storage medium (e.g., a non-transitory computer-readable storage medium). The computer-readable storage medium may comprise any mechanism for storing information in a form readable by a machine or electronic processors/computational device, including, without limitation: a magnetic storage medium (e.g., floppy diskette); optical storage medium (e.g., CD-ROM); magneto optical storage medium; read only memory (ROM); random access memory (RAM); erasable programmable memory (e.g., EPROM and EEPROM); flash memory; or electrical or other types of medium for storing such information/instructions.

The control module 26 is configured to compare the determined compliance score to a safety threshold and to control one or more safety operations at the site 2 in dependence on the comparison. For example, the control module 26 may interact via appropriate network connections with the site safety systems 14, such as the gateway 6 and the notification system 16, to control respective safety operations, such as controlling the gateway 6 to an open or closed state, in dependence on the comparison between the determined compliance score and the safety threshold.

The control module 26 may therefore include suitable control logic, schemes or algorithms for controlling a first set of one or more safety operations in dependence on the determined compliance score being greater than, or equal to, the safety threshold; and a second set of one or more safety operations in dependence on the determined compliance score being less than the safety threshold.

In other examples, the control module 26 may connect to further system such as a PPE storage and/or dispensing system and selectively dispense one or more items of PPE to a detected individual in dependence on the compliance score. For example, where it is found that the integrity of an item of PPE has led to a compliance score that is less than the safety threshold, and by wearing a non-faulty item of PPE the compliance score may be is increased above the safety threshold, then the control module 26 may control the dispensation of the non-faulty item of PPE to the detected individual.

For purposes of this disclosure, it is to be understood that the functional systems, elements, and modules of the control system 1 described herein may each comprise a control unit or computational device having one or more electronic processors. A set of instructions could be provided which, when executed, cause said control unit(s) to implement the control techniques described herein (including the described method(s)). The set of instructions may be embedded in one or more electronic processors, or alternatively, the set of instructions could be provided as software to be executed by one or more electronic processor(s). The set of instructions may be embedded in a computer-readable storage medium (e.g., a non-transitory computer-readable storage medium) that may comprise any mechanism for storing information in a form readable by a machine or electronic processors/computational device, including, without limitation: a magnetic storage medium (e.g., floppy diskette); optical storage medium (e.g., CD-ROM); magneto optical storage medium; read only memory (ROM); random access memory (RAM); erasable programmable memory (e.g., EPROM and EEPROM); flash memory; or electrical or other types of medium for storing such information/instructions.

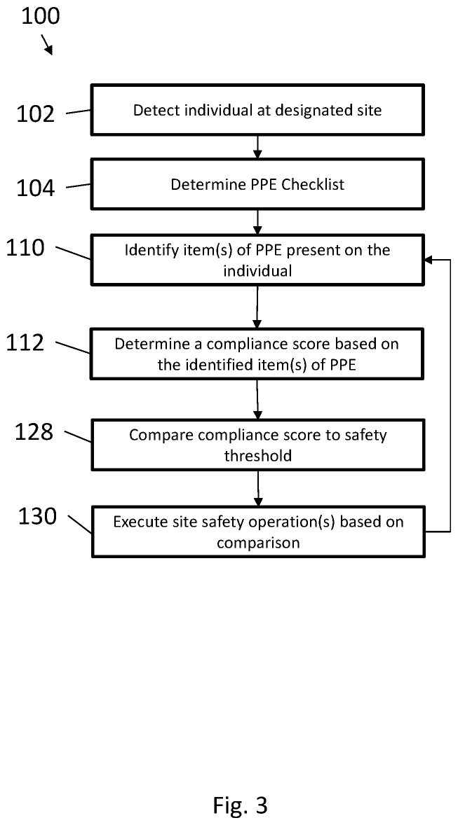

The operation of the control system 1 shall now be described with additional reference to FIGS. 3 to 5.

FIG. 3 shows an example method 100 of operating the control system 1 to control safety operations at the site 2.

In step 102, the control system 1 detects an individual at the site 2. By way of example, on approach to the gateway 6, the individual 14, shown in FIG. 1, may have entered an observed area at the site 2 and the sensor system 10 may record an image of the individual 14 and/or receive a response signal from an RFID tag on the individual 18.

The sensor system 10 transmits sensor data, comprising the recorded image of the individual and the response signal from the RFID tag, to the control system 1. In step 102, the detection module 20 may therefore detect the individual 18 at the site 2 based on the receipt of the response signal and/or by processing the recorded image using an image processing technique. For example, the detection module 20 may process the recorded image to corroborate the detection of the RFID tag on the individual 18 at the site 2. In other examples, an individual may be detected at the site 2 by checking a visual image, a code or a key card in the sensor data.

In this example, the PPE requirements at the site 2 vary for respective individuals according to their identity, job and/or undertakings at the site 2, particularly in respect of the restricted operating area 8. Accordingly, in this example, the method 100 includes the further optional step of determining the PPE requirements for the detected individual 18 in the form of a PPE checklist.

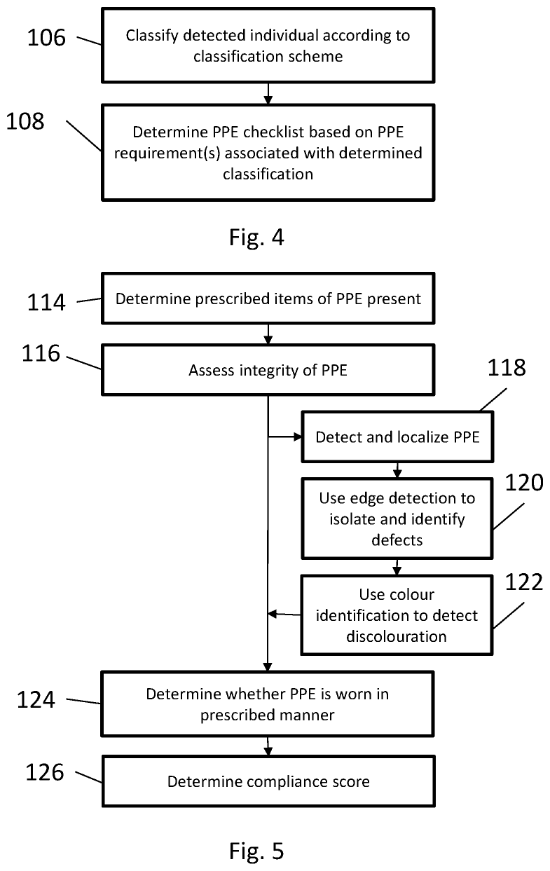

Hence, in step 104, the control system 1 is further configured to determine the PPE checklist for the detected individual 18 based on the sensor data. In examples, determining the PPE checklist may involve identifying the individual 18, with reference to a datastore, and/or classifying the individual 18, with reference to a classification scheme, where the identity and/or classification of the individual 18 may be associated with respective PPE requirements as configured in the system. For example, the method 100 may further includes sub-steps 106 and 108, as illustrated in FIG. 4, which shall now be described in more detail.

In sub-step 106, the control system 1 is configured to determine an identity, a job, and/or an undertaking of the detected individual 18 at the site 2 based on the sensor data and to classify the detected individual 18 accordingly with reference to a classification scheme associated with one or more PPE requirements.

In this example, the individual 18 may be a member of staff, having a job with one or more associated undertakings or activities to be carried out in the restricted operating area 8 of the site 2.

In sub-step 106, the detection module 20 may therefore determine the identity of the individual 18, such as the name ‘JANE DOE’, and the job of the individual 18, such as ‘maintenance worker’, by processing the response signal from the RFID tag and/or by applying an image processing technique to the recorded image. For example, the response signal from the RFID tag may include the name and occupation of the individual 18 or otherwise provide a code for classifying the individual accordingly using the classification scheme. Additionally or alternatively, the detection module 20 may apply an image processing technique to the recorded image and recognise one or more features of the individuals face, or uniform (such as a colour of a particular garment), for example, for comparison to associated identifying features stored in the classification scheme, and thereby classify the detected individual 18 accordingly.

In sub-step 108, the detection module 20 may therefore determine the PPE checklist based on the one or more PPE requirements associated with the classification. For example, the identity ‘JANE DOE’, and/or the job ‘maintenance worker’, may be associated with one or more PPE requirements configured in the classification scheme. The detection module 20 may determine the PPE checklist based on such PPE requirements. For example, as the ‘maintenance worker’ is known to have assigned tasks or undertakings in the restricted operating area 8, the PPE checklist may therefore include a set of prescribed items of PPE, including a hard hat, a high-visibility jacket and a face mask, which are required for the detected individual 18 at the site 2. In other example scenarios, for example where the detected individual is a guest or visitor whose identity is not known, the individual may be classified as a ‘guest’ (e.g. based on an identification tag) and one or more PPE requirements may be stored in the classification scheme for such a classification.

In step 110, the control system 1 identifies any item(s) of PPE on the detected individual 18 based on the sensor data.

Referring to FIG. 1, in this example, the individual 18 is shown to be wearing two items of PPE 19, namely a hard hat and a high-visibility jacket. Accordingly, in step 110, the PPE evaluation module 22 may therefore identify the hard hat and the high-visibility jacket on the detected individual 18 based on the RFID signal and/or the recorded image. For example, the PPE evaluation module 22 may identify the items of PPE by applying an image processing technique to the recorded image, such as a YOLO CNN trained to detect and localise items of PPE in recorded images. Additionally or alternatively, the PPE evaluation module 22 may compare a PPE identifier, such as an identification code, in the response signal from the RFID tag, or the recorded image, to the PPE inventory database and identify the items of PPE based on the comparison.

As a plurality of items of PPE are prescribed in this case, the PPE evaluation module 22 may include one or more rules or algorithms for determining an overall score, or respective item scores, indicative of the presence of the prescribed items of PPE. In an example, the PPE evaluation module 22 may therefore determine a percentage of the prescribed items of PPE that are present on the individual 18. In another example, the PPE evaluation module 22 may be programmed to cease the further evaluation if one or more of the prescribed items of PPE are not present.

In step 112, the control system 1 determines a compliance score based on the identified item(s) of PPE. In particular, the control system 1 is configured to determine a compliance score associated with the detected individual 18 based, at least in part, on the items of PPE identified in step 110, and the extent to which those items satisfy the PPE checklist.

In a basic example, the control system 1 may be configured to determine the compliance score based on the presence or absence of the prescribed items of PPE in the PPE checklist. The determination may be binary, for example, where a score of one is determined if the prescribed item of PPE is present and a score of zero is 0 is determined if the prescribed item of PPE is absent. Where more than one item of PPE is prescribed, the control system 1 may use a weighted average to determine an overall compliance score based on individual item scores.

In other examples, to assess compliance objectively, the control system 1 may be configured to calculate a compliance score based on a plurality of risk factors, including: the prescribed item(s) of PPE, the integrity of identified item(s) of PPE (Visual or otherwise), and whether the identified item(s) of PPE are worn as prescribed for protecting the detected individual, i.e. based on the positioning of the identified item(s) of PPE.

By way of example, FIG. 5 shows example sub-steps 114 to 126 of the step 112 for determining the compliance score.

In sub-step 114, the PPE evaluation module 22 may determine which of the prescribed items of PPE are present on the detected individual. In particular, the PPE evaluation module 22 may compare the items of PPE identified on the detected individual to the prescribed items of PPE and determine, in this example, that the requirements for a hard hat and a high-visibility jacket are satisfied by the detected individual 18. However, the PPE evaluation module 22 may also determine that the requirement for a face mask is not satisfied by the detected individual 18.

In sub-step 116, the control system 1 evaluates the integrity of the identified items of PPE. For this purpose, the PPE evaluation module 22 may use one or more evaluation techniques, including evaluation by reference to the usage records associated with the identified items of PPE and/or inspecting the identified items of PPE for visible defects using an image processing technique. For example, the control system 1 may be configured to assess the integrity by retrieving usage records linked to non-consumable (i.e., not single-use) items of PPE, whilst consumable or low-cost PPE may be visually inspected based on the recorded images in the sensor data.

By way of example, the usage record associated with the identified hard hat may indicate that the integrity of the item is compromised. For example, the usage record may indicate that the hard hat has exceeded a recommended a number of uses, or an expiry date, or that a defect has been recorded for the equipment.

Furthermore, sub-steps 118 to 122 are also illustrated in FIG. 5, to demonstrate how the control system 1 may inspect an item of PPE, such as the high-visibility jacket, for visible defects using an image processing technique applied to a recorded image of the item.

In sub-step 118, the control system 1 is configured to apply an image processing technique to detect and localize the high-visibility jacket in the image. For this purpose, the PPE evaluation module 22 may use one or more objection recognition techniques that are known in the art, such as a YOLO CNN trained to detect and localise such items of PPE in recorded images.

In sub-step 120, the control system 1 may apply an edge detection technique for isolating and identifying visible defects on the high-visibility jacket. For example, the PPE evaluation module 22 may use an edge detection technique in addition to, or as an alternative to, other abnormal feature recognition methods, where the edge detection technique is particularly suited to detecting cracks, tears and other defects forming a discontinuity in the evaluated image.

In sub-step 122, the control system 1 may apply a colour identification technique for detecting discolouring of the high-visibility jacket. Discolouring is another indicator of defect on certain items of PPE, such as eyewear and high-visibility jackets. In this case, the PPE evaluation module 22 may apply such colour identification techniques to identify defects such as burns or a loss of reflectivity of the high-visibility jacket.

In other examples, it shall be appreciated that the control system 1 may evaluate identified items of PPE in a similar manner for a range of visible defects that may affect the integrity of the PPE. Such data may be combined with the usage records, where available, to inform an overall estimate of the integrity of the identified item of PPE, for example to determine whether the identified item of PPE has sufficient integrity for effective protection, as necessary for compliance with the PPE checklist.

Again, the PPE evaluation module 22 may include one or more rules or algorithms for determining an overall score, or respective item scores, indicative of the integrity of the identified items of PPE.

In sub-step 124, the control system 1 may determine whether the identified items of PPE are being worn in the prescribed manner for effective use. For example, the control system 1 may determine the position of the identified items of PPE on the detected individual using a detection and localization method, substantially as described in sub-step 122, applied to the recorded image in the sensor data. The PPE evaluation module 22 may then compare the detected position to a prescribed position for said item of PPE. The prescribed position may be stored in the PPE inventory database or the prescribed position may be otherwise determined or derived based on a respective rule or algorithm. For example, a machine learning algorithm of the PPE evaluation module 22 may be trained to determine a prescribed position for wearing a respective item of PPE based on labelled datasets and/or a physical model. By way of example, the PPE evaluation module 22 may determine that the hard hat is positioned on top of the head of the detected individual 18 and that the high-visibility jacket is being worn as an outer layer of clothing, and thereby determine, in sub-step 124, that the identified items of PPE are being worn in the prescribed manner for effective use.

Once again, the PPE evaluation module 22 may include one or more rules or algorithms for determining an overall score, or respective item scores, indicative of whether the identified items of PPE are being worn in the prescribed manner.

In sub-step 126, the control system 1 determines an overall compliance score associated with the detected individual 18. For this purpose, the PPE evaluation module 22 may, for example, use one or more respective rules, or algorithms, or apply the compliance matrix to combine the risk factors assessed in sub-steps 114 to 124 to determine an overall compliance score.

For example, at the end of sub-step 124, the PPE evaluation module 22 may have determined an item score for each of the prescribed items of PPE based on the presence of said item on the detected individual, the integrity of the detected item and the position of the detected item on the individual. The control system 1 may then determine an overall compliance score as a weighted average of the item scores. The relative weighting of each item score may be indicative of the importance of the respective item of PPE to the safety of the individual and/or compliance with health and safety requirements at the site 2. System operators can configure the weighting of the prescribed items to suit a risk profile (e.g. hard hat compliance ranked above high-visibility jacket) and the respective weightings may be stored in the memory module 24, for example.

Returning to FIG. 3, in step 128, the control system 1 may proceed to compare the determined compliance score to a safety threshold. The safety threshold may be calibrated (along with the algorithms used to determine the compliance score) to ensure that a user associated with a compliance score that is greater than, or equal to, the safety threshold complies with minimum safety requirements, as set by a system operator for the site 2.

For example, in this case, the control system 1 may determine that the compliance score associated with the detected individual 18 is less than the safety threshold. In particular, although the item scores associated with prescribed hard hat and high-visibility jacket may be sufficient, the prescribed face mask was not identified on the detected individual 18 and so the determined compliance score may indicate that the individual 18 has failed to comply with the PPE checklist.

In step 130, the control system 1 may proceed to execute one or more safety operations at the site 2 based on the comparison of the compliance score to the safety threshold. For example, as the compliance score is determined to be less than the safety threshold, control module 26 may interact with the gateway 10 to prevent the detected individual 18 from entering the site 2. Additionally, or alternatively, the control system 1 may operate the notification system 16 generate an audible or visual alert, to notify the detected individual 18 that they have failed to comply with the PPE requirements associated with the site 2. Such notification may, for example, indicate that the detected individual 18 is missing a required face mask. Such notification shall allow the detected individual 18 to make suitable corrections.

Thereafter, in examples, the control system 1 may control the sensor system 10 to continue monitoring the detected individual 18 as a permanent background activity while the detected individual 18 remains in an observed area at the site 2. For example, sensing computations may take place at predetermined intervals, or according to some other predetermined strategy.

In this manner, the control system 1 may proceed to determine, i.e. redetermine, the compliance score associated with the detected individual 18 (according to step 112) periodically and/or in dependence on detecting a change in the identified items of PPE present on the detected individual. For example, redetermining the compliance score if there is a change in one of the factors used to assess the compliance, including for example, the presence, integrity, or position on the individual, of the prescribed items of PPE.

If the control system 1 subsequently determines, in step 128, that the compliance score has increased to, or above, the safety threshold, the control system 1 may control the removal of one or more restrictions at the site 2, for example controlling the gateway 6 to allow the detected individual 18 to enter the site 2 and deactivating the notifications. It shall be appreciated that, once inside the site 2, the individual 18 is monitored further such that if the detected individual 18 subsequently removes one of the identified items of PPE, or the integrity of any of the identified items of PPE changes, the compliance score may be determined again and further safety operations may be executed if the compliance score subsequently reduces below the safety threshold again.

In this manner, the location where an individual enters the site 2 may provide the primary evaluation point, with access being controlled to allow the individual to enter the site 2 if they satisfy a number of configurable risk factors (e.g., PPE present, appropriately worn, PPE expiration date/status, etc). Thereafter, the individual is further monitored by various sensors, such as a number of cameras, arranged around the site 2, remotely monitoring areas of interest and transmitting visual data to the control system 1 for further compliance assessment.

As a result of the method 100, it is envisaged that the safety of the individuals at the site 2 will be enhanced, with PPE infractions being substantially eliminated or reduced, leading to increased compliance with the PPE requirements.

It shall be appreciated that the control system 1 is applicable to various sites and may, for example, be deployed in a construction site, a hospital, or any other environment where PPE is required. It is noted that the steps of the method 100 are only provided as a non-limiting example of the disclosure, and many modifications may be made to the above-described examples without departing from the scope of the appended claims.

In other examples, if a detected individual is classified, the recorded image, identification tag or other identifier used to classify the detected individual may be stored in the memory module 24 of the control system 1, along with a timestamp, for example. Similarly, the item(s) of PPE identified, in step 110, and/or the classification score, determined in step 112, may be stored in the memory module 24 of the control system 1, along with a timestamp, for example. Storing such information may demonstrate the execution of appropriate risk mitigation protocols.

In a further example, the control system 1 may be further configured to control one or more safety operations at the site 2 in dependence on the compliance of the detected individual with social distancing protocols.

For example, the control system 1 may be configured to determine the proximity of the detected individual 18 to another individual at the site 2 and to determine a compliance score, substantially as described above, based, at least in part, on a comparison between the determined proximity and a threshold proximity for social distancing.

As shall be described in more detail, the proximity may be determined based on the sensor data received from the sensor system 10, and particularly based on one or more recorded images of the individuals at the site 2. In particular, the control system 1 may calculate the proximity of the individuals by determining a scalar conversion from a pixel in the image to a real-world, physical, distance measurement. The scalar conversion may be determined based on a priori knowledge of the focal length of the sensor 12 that recorded the image and a configurable reference size, such as a reference height in metres, relating to the assumed real-world size of the individuals in the image.

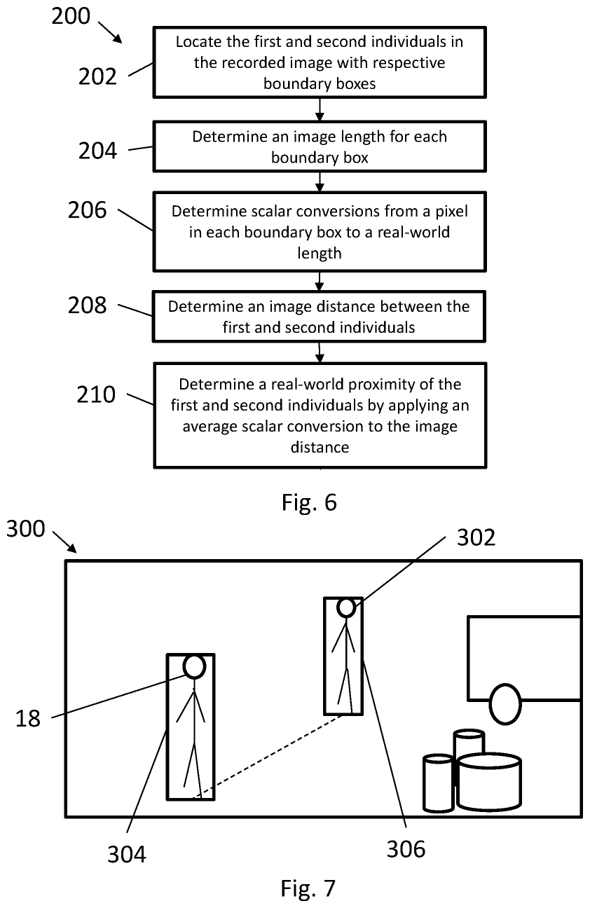

By way of example, FIG. 6 describes a method 200 of determining the proximity of first and second individuals featured in an exemplary image 300, shown in FIG. 7, recorded by the sensor system 10.

In step 202, the control system 1 may be configured to locate the first individual 18 and the second individual 302 in the recorded image 300 with respective boundary boxes 304, 306. For example, the control system 1 may use one or more object recognition techniques that may include a machine learning algorithm trained to locate respective individuals in a recorded image and label the image 300 with first and second respective boundary boxes 304, 306.

In step 204, the control system 1 may be configured to determine respective image lengths, as a pixel count, for each of the first and second boundary boxes 304, 306. For example, the control system may be configured to count the number of pixels from a bottom edge to a top edge of each boundary box 304, 306.

In step 206, the control system 1 determines a real-world length, or physical distance, corresponding to a pixel in each boundary box 304, 306. In particular, the control system 1 may determine, for each boundary box 304, 306, a scalar conversion between a pixel in the boundary box 304, 306 and a respective real-world distance. Taking the first boundary box 304 as an example, the scalar conversion may be determined based on a focal length of the sensor 12 that recorded the image 300 and a reference height of the individual 18, which may be set as 170 cm for example. In this manner, the scalar conversion, i.e. the distance per pixel in the first boundary box 304, may be determined according to the following equation:

Distance (m)=((Reference Height (m)×focal length (m))/image height (pixel count))

The scalar conversion between a pixel in the second boundary box 308 and a real-world distance may then be determined according to the same equation applied to the second boundary box.

In step 208, the control system 1 may then calculate the spacing between the first and second individuals 18, 302, as a pixel count. For example, the control system 1 may use the bottom centre of each boundary box 304, 306 as a positional reference for the respective individual 18, 302 and an L2 normalization relationship to determine an estimation of the distance, in pixels, between the first and second individuals 18, 302 in the image 300.

In step 210, the control system 1 may determine the proximity of the first and second individuals 18, 302 (as a real-world distance) by determining an average of the scalar conversions determined in step 206, and applying the average scalar conversion to the spacing, in pixels, determined in step 208.

Having determined the proximity of the first and second individuals 18, 302, the control system 1 may be configured to compare the determined proximity to a threshold for social distancing and thereby determine whether social distancing protocols are adhered to. In an example, the control system 1 may be configured to vary the threshold for social distancing based on the items of PPE identified on the detected individual 18 (in step 110) and/or the identity of the detected individual 18. For example, if the control system 1 identifies a face mask on the detected individual 18, the threshold for social distancing may be reduced accordingly.

It shall be appreciated that the control system 1 may be operated according to the method 200 to determine a respective risk factor, which accounts for social distancing protocols, that may be built into the compliance score determined according to the method 100 (e.g. as part of the compliance matrix). In other examples, the control system 1 may be operated according to the method 200 to assess the compliance of the detected individual 18 with the social distancing protocols separately to the compliance with the PPE requirements. For example, the control system 1 may proceed to assess the compliance with the social distance protocols according to the method 200, based on sensor data received from the sensor system 10, and determine a compliance score based on the assessment for controlling the site safety systems 6 substantially as described in steps 126 and 128.

In this manner, the technology can encourage social distancing and the control system 1 may control the site safety systems 14 to execute one or more safety operations in dependence on the compliance with the social distancing protocols. For example, if the determined proximity is less than the threshold for social distancing, the control system 1 may operate the notification system 16 to generate a corresponding notification and/or to remind individuals at the site 2 of the social distancing requirements.

In an example, the control system 1 may be configured to continuously monitor social distancing among individuals at the site 2, according to the method 200, so that people are not in close contact for more than a threshold amount of time.

1. A computer-implemented method of controlling safety operations at a designated site associated with Personal Protective Equipment (PPE) requirements, the method comprising:
receiving sensor data from a sensor system monitoring the site;
detecting an individual at the site based on the sensor data;
identifying one or more items of PPE present on the individual based on the sensor data;
determining a compliance score associated with the individual based, at least in part, on the one or more identified items of PPE and a PPE checklist associated with the designated site, the PPE checklist comprising one or more prescribed items of PPE;
comparing the compliance score to a safety threshold; and
controlling one or more safety operations at the site in dependence on the comparison between the determined compliance score and the safety threshold.

2. The method according to claim 1, wherein the sensor data comprises:
a recorded image of the individual at the site;
an identification tag detected on an individual at the site; and/or
a key code provided by an individual at the site.

3. The method corroding to claim 2, wherein the sensor data comprises the recorded image of the individual at the site, and wherein the individual is detected and/or the one or more items of PPE are identified based, at least in part, on an image processing technique applied to the recorded image of the detected individual.

4. The method according to claim 1, further comprising:
determining an identity of the detected individual,
a job title of the detected individuals, and/or
an undertaking of the detected individual at the designated site;
determining the PPE checklist based on the determined identity, job title, and/or undertaking of the detected individual;
classifying the detected individual according to the determined identity, job title, and/or undertaking of the detected individual, the classification being associated with one or more respective PPE requirements; and
determining the PPE checklist based on the classification.

5. (canceled)

6. The method according to claim 1, wherein determining the compliance score associated with the detected individual comprises:
determining whether the one or more prescribed items of PPE are identified on the detected individual;
assessing the integrity of the one or more identified items of PPE based on the sensor data; and/or
determining whether the one or more identified items of PPE are worn as prescribed for protecting the detected individual based on the sensor data.

7. The method according to claim 6, wherein determining the compliance score comprises assessing the integrity of the one or more identified items of PPE, and wherein assessing the integrity comprises:
retrieving one or more usage records associated with the one or more identified items of PPE from an inventory database, each usage record being indicative of the condition of a respective item of PPE; and/or
applying an image processing technique to a recorded image of the detected individual in the sensor data to inspect the one or more identified items of PPE for visible defects.

8-9. (canceled)

10. The method according to claim 6, wherein the image processing technique detects the visible defect using a machine learning algorithm for detecting the visible defect in the recorded image, and/or an edge detection technique, and/or using a colour identification technique for identifying discolouration of the identified item of PPE.

11. The method according to claim 6, wherein determining the compliance score comprises determining whether the one or more identified items of PPE are worn as prescribed for protecting the detected individual, and wherein determining whether the one or more identified items of PPE are worn as prescribed comprises:
determining a position of each identified item of PPE on the detected individual; and
comparing the determined position of said item of PPE to a position prescribed for said item of PPE in the PPE checklist.

12. The method according to claim 11, wherein determining the position of each identified item of PPE comprises localising the identified item of PPE on the detected individual using an object recognition technique applied to a recorded image of the detected individual in the sensor data; preferably wherein the object recognition technique comprises a convolutional neural network; further preferably wherein the object recognition technique comprises a you-only-look-once convolutional neural network.

13. The method according to claim 1 wherein the PPE checklist includes a plurality of prescribed items of PPE, and wherein determining the compliance score comprises:
determining, for each of the prescribed items of PPE, an item compliance score indicative of the presence of the prescribed item of PPE on the detected individual, the integrity of said item of PPE, and/or whether the item of PPE is worn as prescribed for protecting the detected individual; and
determining the compliance score as a weighted average of the item compliance scores.

14. The method according to claim 1, wherein executing the one or more safety operations at the site comprises:
controlling one or more site restrictions;
dispensing one or more items of PPE at the site; and/or
controlling a notification system to indicate the compliance of the detected individual with the PPE checklist.

15. The method according to claim 14, wherein the individual is detected at an entrance and/or an exit to the site, and wherein controlling the one or more site restrictions comprises controlling a state of the entrance and/or the exit for the detected individual.

16. The method according to claim 14, wherein the one or more site restrictions are controlled to:
enable the detected individual to perform the determined undertaking in dependence on the compliance score being greater than, or equal to, the safety threshold; and/or
inhibit the detected individual from performing the determined undertaking in dependence on the compliance score being less than the safety threshold.

17. The method according to claim 1, further comprising monitoring the individual, once detected, to detect a change in the one or more identified items of PPE present on the detected individual based on the sensor data, wherein the compliance score is determined periodically, and/or in dependence on detecting the change in the one or more identified items of PPE present on the detected individual.

18. (canceled)

19. The method according to claim 17, further comprising:
removing one or more site restrictions in dependence on the determined compliance score increasing to, or above, the safety threshold; and/or
applying one or more site restrictions in dependence on the determined compliance score decreasing below the safety threshold.

20. The method according to claim 17, further comprising:
determining a proximity of the monitored individual to another individual at the designated site based on the sensor data, and
determining the compliance score based, at least in part, on the determined proximity being less than a threshold proximity for social distancing,
determining the threshold proximity based on the one or more identified items of PPE.

21. The method according to claim 20, wherein the sensor data comprises a recorded image of the detected individual and the other individual at the site; and wherein the proximity is determined by:
locating the detected individual in the recorded image;
locating the other individual in the recorded image;
determining an image distance, in pixels, from the detected individual to the other individual; and
determining the proximity using a scalar conversion from the image distance to a physical distance, where the scalar conversion is based, at least in part, on a focal length of an image sensor that recorded the image.

22. The method according to claim 21, further comprising determining the scalar conversion by:
determining a first boundary box for the detected individual in the recorded image;
determining a second boundary box for the other individual in the recorded image;
determining a first length, in pixels, of the first boundary box and a second length, in pixels, of the second boundary box;
determining a first scalar conversion from a pixel in the first boundary box to a physical distance based on:
a focal length of the image sensor, a reference size of the detected individual and the first length;
determining a second scalar conversion from a pixel in the second boundary box to a physical distance based on:
a focal length of the image sensor, a reference size of the other individual and the second image length; and
averaging the first and second scalar conversions.

23. (canceled)

24. A control system for controlling safety operations at a designated site associated with Personal Protective Equipment (PPE) requirements, the control system being configured to execute instructions to:
receive sensor data from a sensor system monitoring the site;
detect an individual at the site based on the sensor data;
identify one or more items of PPE present on the individual based on the sensor data;
determine a compliance score associated with the individual based, at least in part, on the one or more identified items of PPE and a PPE checklist associated with the site;
compare the compliance score to a safety threshold; and
control one or more safety operations at the site in dependence on the comparison between the determined compliance score and the safety threshold.

25. A computer-implemented method of controlling safety operations at a designated site associated with social distancing requirements, the method comprising:
receiving a recorded image from a sensor system monitoring the site;
locating first and second individuals in the recorded image;
determining an image distance, in pixels, from the first individual to the second individual;
determining a proximity of the first and second individuals using a scalar conversion from the image distance to a physical distance, where the scalar conversion is based, at least in part, on a focal length of an image sensor that recorded the image; and
controlling one or more safety operations at the site in dependence on the determined proximity.
